(19) United States
(12) Patent Application Publication
(10) Pub. No.: US 2019/0026434 A1
(43) Pub. Date: Jan. 24, 2019

(54) SYSTEM AND METHODS OF ACTIVITY TRACKING WITHIN ELECTRONIC MEDICAL RECORDS

(71) Applicant: CERNER INNOVATION, INC., KANSAS CITY, KS (US)

(72) Inventors: Sudesh Yadav, Rewari (IN); Revathi Sankar, Chennai (IN); Prashanth Kumar Chandrappa Nanjamma, Bangalore (IN); Vidhya Devi, Bangalore (IN)

(21) Appl. No.: 15/653,113

(22) Filed: Jul. 18, 2017

(51) Int. Cl. G06F 19/00

(52) U.S. Cl. CPC G06F 19/322; G06F 21/6245

(57) ABSTRACT

Methods, systems, and computer-readable media are provided for computer-based activity tracking within electronic medical records. Generally a user (e.g., a medical professional) logs in to electronic medical record software and performs various actions in an electronic medical record. Corresponding audit events are logged in an events database. A reviewer (e.g., in the electronic medical record software) requests to view a selected user's activity history comprising the actions performed by the user in one or more electronic medical records. For example, a user can request to view his or her own activity history, or a manager can request to view a reportee's activity history. The system determines whether the reviewer is authorized to view the selected user's activity history, and if the reviewer is authorized, a user activity component (e.g., in the electronic medical record software) fetches information identifying the selected user's actions from the events database and presents the activity history as a read-only list of actions. Each action in the activity history can include a hyperlink to a corresponding electronic medical record component in which the action was generated. In this manner, the disclosed systems and methods provide an experience that integrates electronic medical records with the ability to review user activity history.

### BACKGROUND

In general, medical facilities use software to maintain electronic medical records for individuals. The software can include components corresponding to various aspects of a medical record such as diagnoses, problems, vital signs, results review, clinical notes, allergies, medication list, immunization schedule, history (e.g., family history, procedure history, past medical history), individual care summary, etc. Generally, users of electronic medical record software can take action in an electronic medical record, for example, by entering or editing information for an individual. Actions taken in electronic medical records are generally recorded and stored in events databases for future audits.

### SUMMARY

Embodiments of the present invention provide methods and systems for implementing activity tracking within electronic medical records. In general, users perform various actions in electronic medical record components, and an audit event corresponding to each action is logged in an events database. A requesting user can request access to an activity history for a selected user comprising actions performed by the selected user in the electronic medical record. When it is determined that the requesting user is authorized to access the selected user's activity history, information about each action is fetched from logged audit events, and the information is provided for display to the requesting user as an activity history. Each action in the activity history can be provided as a hyperlink to a corresponding electronic medical record component in which the action was generated. In this manner, the disclosed system and method facilitates efficient and quick activity tracking within electronic medical records.

At a high level, a system for implementing activity tracking in electronic medical records includes a hardware processor and memory. The hardware processor is configured to perform a predefined set of basic operations in response to receiving a corresponding basic instruction selected from a predefined native instruction set of codes. The system includes an electronic medical records manager and an event manager. The electronic medical records manager includes sets of machine codes selected from the native instruction set and configured to receive a request from a first user to perform an action in a component of an electronic medical record, and perform the action in an electronic medical records database. The event manager includes sets of machine codes selected from the native instruction set and configured to log an audit event corresponding to the action in an events database, receive a request from a second user to access an activity history for the first user comprising actions performed by the first user in the electronic medical record, determine whether the second user is authorized to access the activity history, fetch information about the action from the logged audit event when the second user is authorized, and provide the information for display to the second user as an activity history.

### BRIEF DESCRIPTION OF THE DRAWINGS

Embodiments are described in detail below with reference to the attached drawing figures, wherein:

FIG. 1 is a block diagram of an exemplary autonomous activity tracking system for electronic medical records, in accordance with embodiments described herein;

FIG. 2 depicts an exemplary user interface displaying a component of an electronic medical record, in accordance with embodiments described herein;

FIG. 3 depicts exemplary data fields in a conventional events database, in accordance with embodiments described herein;

FIG. 4 depicts exemplary data fields describing electronic medical record actions, in accordance with embodiments described herein;

FIG. 5 depicts an exemplary user interface displaying user activity within an electronic medical record, in accordance with embodiments described herein;

FIG. 6 depicts an exemplary user interface displaying user activity within an electronic medical record, in accordance with embodiments described herein;

FIG. 7 is a flow diagram showing an exemplary method for providing an autonomous user activity tracking system, in accordance with embodiments described herein;

FIG. 8 is a block diagram of an exemplary computing environment suitable for use in implementing embodiments described herein.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Electronic medical records for individuals are generated and maintained in various health care settings. Since the same individual can visit multiple medical facilities and multiple departments within the same facility, the individual's electronic medical record is ideally available to multiple medical professionals from multiple facilities and/or multiple entities. Thus, electronic medical record software such as Cerner's PowerChart® provides access to electronic medical records to various users (e.g., medical professionals) across various sites. When users interact with electronic medical records, user actions performed in the records can be recorded for auditing purposes. For example, Cerner's P2Sentinel Enterprise software collects, analyzes and retains event log data for inclusion in an events database.

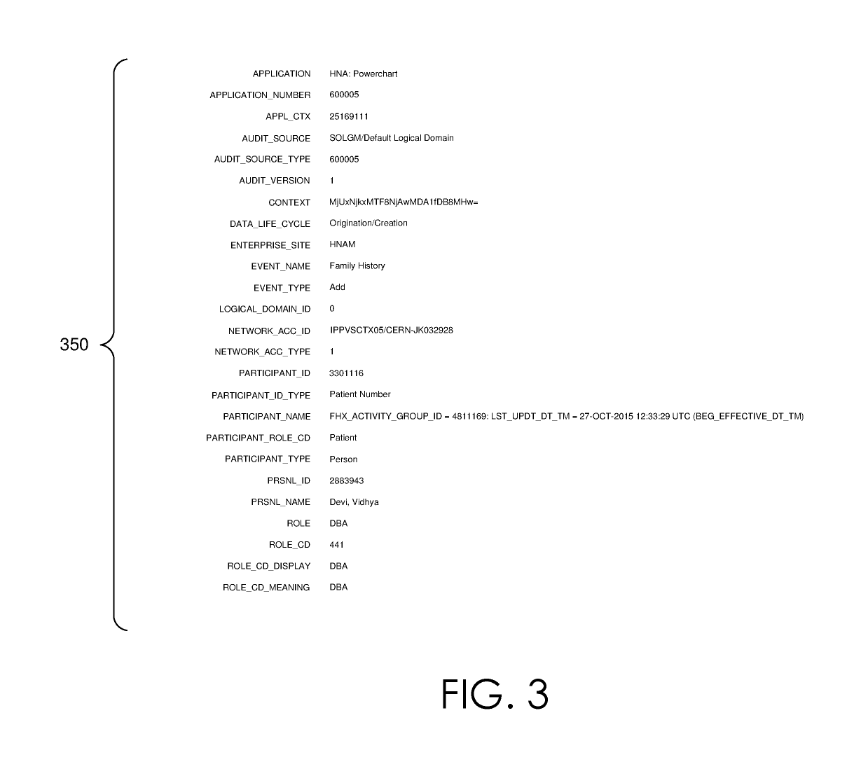

However, conventional methods for maintaining and accessing user activity in electronic medical records have several shortcomings. For example, conventional electronic medical record software does not provide users with a way of viewing their own electronic medical record activity history (e.g., for learning purposes, to revisit his/her history of action, etc.). There is likewise no way for managers to view the activity histories of their reportees within electronic medical record software (e.g., to perform supervisory functions). Moreover, an events history from a conventional events database is not configured to provide or otherwise present information focused specifically on a particular user's activity history within an electronic medical record. For example, FIG. 3 depicts exemplary data fields 350 stored in a conventional events database. As can be appreciated, information stored in such an events database includes detail which may not be of interest and is not typically presented to facilitate quick and focused review from an electronic medical record software user. As such, the presentation of an events history from conventional events databases (e.g., an audit report) would introduce inefficiencies and inconvenience for users requesting and attempting to review an activity history of a user. Other variations and combinations of shortcomings exist with conventional methods for maintaining and accessing user activity in electronic medical records. As such, processes to support autonomous activity tracking within electronic medical record software are integral to the efficient review of user actions.

Accordingly, embodiments of the present invention are directed to methods, systems, and computer-readable media for a system and method for implementing autonomous activity tracking within electronic medical record software and related applications. At a high level, users of electronic medical record software (e.g., medical professionals) log in and perform various actions within electronic medical record components. For example, a medical professional can access a Family History component of an electronic medical record for an individual to add an entry regarding that individual's family history. Each action performed in the electronic medical record is logged in an events database. Authorized users can view a history of the action performed by a given user. For example, the medical professional and the medical professional's supervisor may be given access to the medical professional's activity history. A component fetches the relevant activity history from the events database and displays the history to the authorized user. Each displayed action includes a hyperlink to the electronic medical record component in which the action was generated. In this manner, the system and method facilitates efficient and quick activity tracking within electronic medical records.

In general, an application, plug-in, tool, or other type of software can be provided to allow authorized users (e.g., medical professionals) to interact with electronic medical records. For example, users can provide login credentials which authorize them to access and/or edit one or more aspects of an electronic medical record for an individual. The electronic medical record software can include one or more components corresponding to various aspects of an electronic medical record. By way of nonlimiting example, such components can include components for diagnoses, problems, vital signs, results review, clinical notes, allergies, medication list, immunization schedule, history (e.g., family history, procedure history, past medical history), individual care summary, etc. Users can take action in one or more components, for example, to input or edit information in the electronic medical record. Such user activity in electronic medical records is recorded in an events database.

For example, one or more computing devices (e.g., servers) can manage data, and access to data, stored in one or more databases. In some embodiments, users (e.g., clients) request ad and write access to an electronic medical records database, and the system authenticates user's identity and authorizes the user with the appropriate (e.g., assigned) rights. Various types of authentication and authorization are known and are contemplated within the present disclosure. By way of nonlimiting example, a user may transmit credentials to a central server that has access to a security database including credentials and corresponding access rights. The server can authenticate the user using the received credentials and the security database e.g., at login) and grant appropriate access rights (e.g., at login, at the time of a request, otherwise). In this way, a user can be granted access to an electronic medical records database.

In embodiments that include a client-server configuration, a user on a client device can take action within a component of an electronic medical record such as requesting to add information to the record. In embodiments, the request is transmitted to a server which manages access to an electronic medical records database. If the user is/was granted write access (e.g., for that individual, to the entire electronic medical records database, etc.), the server can store the data for future retrieval by authorized users. In addition, certain events are stored in an events database for auditing purposes. For example, any time a user enters information into an electronic medical record, a record of the action can be stored. In some embodiments, all read and right requests are stored in the events database. Generally, incoming requests (e.g., to write to an electronic medical record) are evaluated to determine whether the type of request is one which has been determined to be recorded, and if it is, the corresponding event information (e.g., user, type of request, details of request, time of request, etc.) is stored in the events database. In embodiments that include multiple servers, client requests can be distributed to each server (e.g., using a publish-subscribe configuration) or requests can be forwarded (e.g., by a component on one or more servers that intercept and/or duplicate relevant requests for forwarding, etc.). Various other network configurations for recording actions taken in electronic medicals records can be understood by those with ordinary skill in the art.

The electronic medical record software provides access to a user's activity history. For example, a component of the electronic medical record software on a user device can permit users to request a history of the actions taken in a given electronic medical record. For example, a user can request his or her own activity history or the activity history for another user. Additionally, the requested activity history can be for actions taken by the user in particular electronic medical record or across all electronic medical records. Access can be granted, for example, for each user to view his or her own activity history and for supervisors to view the activity histories of their reportees. For example, access rights can be granted to predetermined individuals (e.g., and stored in the security database), and the system (e.g., a server) can determine whether a user is authorized to access the requested activity history (e.g., at the time of a request, at login, etc.). When the system determines that access is authorized, selected event information is accessed from the events database corresponding to the activity history and electronic medical record of interest. This information is then provided to the user in a user-friendly, and preferably read-only format.

In some embodiments, each action contained in a user activity history includes a hyperlink to a corresponding electronic medical record component. For example, where the activity history indicates a user previously entered vital signs for an individual, the activity history can display this action as a hyperlink to a vital signs component of the electronic medical record. If by chance a reviewer has closed a given component by mistake, the reviewer can revisit the component by simply clicking on the action hyperlink in the activity history to provide seamless navigation between components. In this manner, the activity history provides an experience that integrates user activity history and electronic medical records.

As such, activity tracking within electronic medical records can be achieved by providing select access to a user's activity history. Accordingly, the autonomous activity tracking system provides authorized users with instant, on-demand access to information about actions taken by a selected user in one or more electronic medical records. In this regard, the autonomous activity tracking system utilizes a novel configuration of network components to provide authorized users with valuable information that was not previously available using conventional electronic medical record software. Similarly, the provision of actions in a user activity history to include hyperlinks to corresponding components of electronic medical records likewise provides a novel configuration that enhances the activity review process to provide seamless integration with electronic medical record software.

The claimed solution is necessarily rooted in computerized medical technology in order to overcome a problem specifically arising in the realm of medical information networks. For example, as medical information systems have migrated to electronic environments, inefficient access to user activity history has produced suboptimal review processes in computerized medical facilities. Attempting to access a user's electronic medical record activity history using conventional events databases involves significant human intervention, which can be time consuming, inefficient, and susceptible to human error.

The claimed invention overcomes the limitations of current medical information networks accessible in computerized medical facilities, for example, by utilizing instant, on-demand access to an individual's activity history, thereby rendering the review process more efficient, user-friendly and cost-effective. Observers will notice improved performance, for example, based on the autonomously generated and focused indications of user action disclosed herein. Such features will reduce the number of “clicks” or entries a computer user has to make and results in reducing the memory utilization, CPU cycles, number of operations that need to be performed by the computer, and power consumption. The resulting cost savings and operational efficiencies of the autonomous activity tracking system magnify the potential benefits of this technology

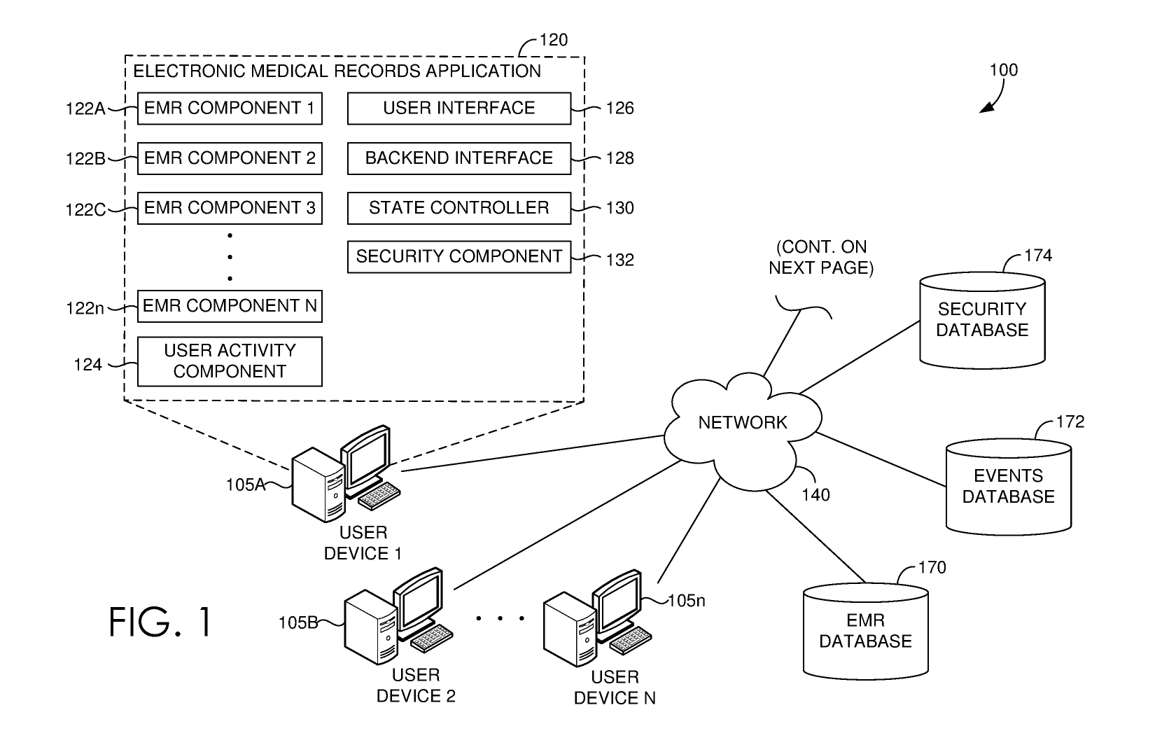

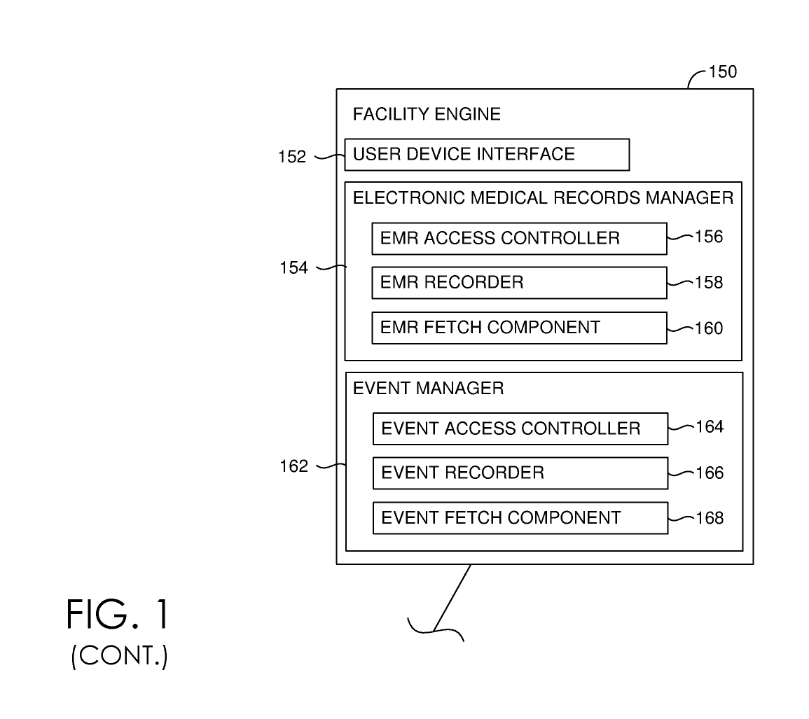

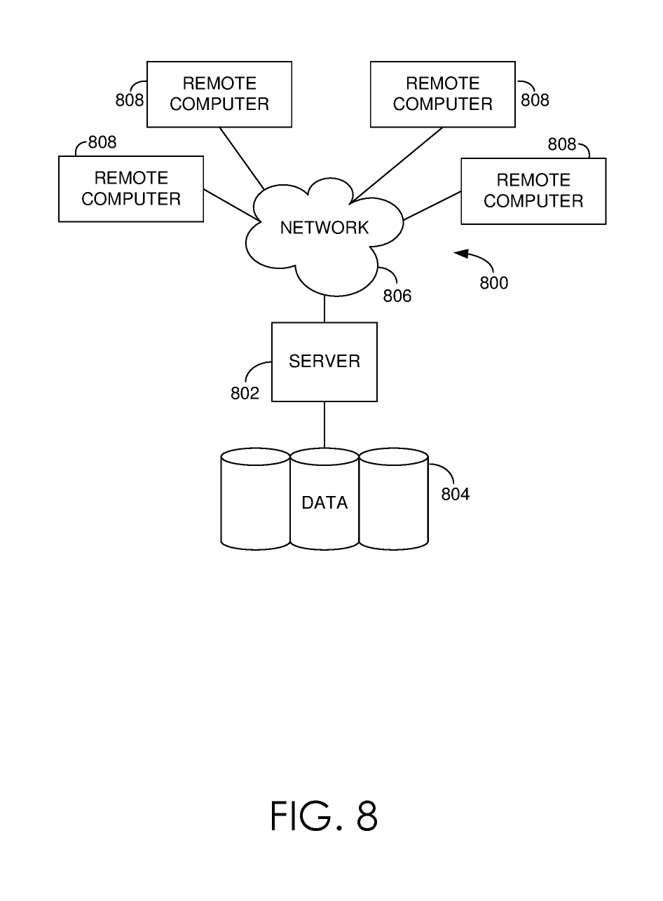

With reference to FIG. 1, embodiments of the present disclosure can be discussed with reference to an exemplary computing environment, such as the one illustrated in FIG. 8 and explained in more detail below, that serves as an operating environment for implementing the functionality described herein with respect to autonomous activity tracking system 100.

FIG. 1 depicts exemplary autonomous activity tracking system 100. Autonomous activity tracking system 100 includes user devices 105A, 105B, . . . , 105n, network 140, facility engine 150, electronic medical records database 170, events database 172 and security database 174. In the embodiment exhibited by FIG. 1, the processing duties may but need not be split among several computing systems and/or devices, each comprising one or more processors. By way of nonlimiting example, autonomous activity tracking system 100 can distribute processing duties among facility engine 150 and any of user devices 105A, 105B, . . . , 105n. The tasks performed by the components of autonomous activity tracking system 100 utilize a variety of computer and/or networking technology. In one embodiment, the technology can be divided into three tiers, web server, application server and database server, each tier comprising multiple layers, as can be understood a person of ordinary skill in the art having the benefits of the present disclosure. FIG. 1 depicts an embodiment with three separate databases, however, in some embodiments the corresponding storage can be implemented using any number of databases (e.g., one or more) and/or a database system. Although electronic medical records are specifically referred to herein, references to electronic medical records should be read to include electronic health records, as well. Network 140, such as the internet or other public or private network, serves as a communications link for the components of autonomous activity tracking system 100.

In the embodiment depicted in FIG. 1, each user device 105A, 105B, . . . , 105n includes electronic medical records application 120. Although depicted as a stand-alone application residing on a user device, software providing the functionality described herein with respect to electronic medical records application 120 can reside on any number of devices (e.g., one or more of user devices 105A, 105B, . . . , 105n and/or facility engine 150, whether alone or in combination), and can be accessible to a user using an application, plug-in, tool or other software on a user device.

Electronic medical records application 120 includes electronic medical record (EMR) components 122A, 122B, 122C, . . . , 122n, user activity component 124, user interface 126, backend interface 128, state controller 130 and security component 132. Components 122A, 122B, 122C, . . . , 122n can include, for example, components for diagnoses, problems, vital signs, results review, clinical notes, allergies, medication list, immunization schedule, history (e.g., family history, procedure history, past medical history), individual care summary, etc. Each component can include a pre-defined configuration, orientation and formatting of various subcomponents for providing a user with the ability to retrieve, display, manipulate and create information relating to the corresponding component of an electronic medical record. For example, electronic medical records application 120 can include a graphical user interface (e.g., user interface 126) with which a user can select a desired electronic medical record component. Based on a user selection received (e.g., via user interface 126), state controller 130 deter corresponding component 122A, 122B, 122C, . . . , 122n to display via the graphical user interface. Although electronic medical records application 120 is depicted in FIG. 1 as including interface components 126 and 128, each of components 122A, 122B, 122C, . . . , 122n could include their own I/O functionality.

Electronic medical records application 120 can facilitate user authentication and/or authorization using security component 132. For example, security credentials provided by a user via user interface 126 can be used to authenticate and authorize a user with pre-defined rights (e.g., read/write access for electronic medical records, read rights for activity histories for selected users, etc.). For example, security component 132 can coordinate authentication and authorization with facility engine 150 (e.g., via backend interface 128). Various types of authentication and authorization are known in the art and are contemplated within the presentation disclosure. For example, security component 132 can send authentication and/or authorization requests to facility engine 150, which can determine whether to authenticate the user and/or grant the user access rights by comparing credentials transmitted in a request with information (e.g., security credentials, access rights, privilege settings, etc.) stored in security database 174. In embodiments, security component 132 can determine whether a user is authorized to access EMR database 170 (e.g., via communication with EMR access controller 156 of electronic medical records manager 154 and user device interface 152 of facility engine 150) and/or whether a user is authorized to access one or more activity histories using information stored in events database 172 (e.g., via communication with event access controller 164 of event manager 162 and user device interface 152 of facility engine 150). In embodiments where authentication and/or authorization for a user occur when a user logs in to electronic medical records application 120, security component 132 can maintain a security record of the authentication and/or authorization (e.g., a digital certificate issued by facility engine 150) for the user's session. In these embodiments, security component 132 can include the security record in the user's requests (e.g., read/write) for access to EMR database 170 and/or events database 172 a given login session.

Facility engine 150 includes user device interface 152, electronic medical records manager 154 and event manager 162. User device interface 152 generally provides the interface to facility engine 150 for user devices 105A, 105B, . . . , 105n (e.g., via backend interface 128 of electronic medical records application 120). Electronic medical records manager 154 manages access to electronic medical records database 170, and event manager 162 manages access to events database 172.

Electronic medical records manager 154 includes EMR access controller 156, EMR recorder 158 and EMR fetch component 160. Generally, EMR access controller 156 receives requests for access to EMR database 170. For example, when a user wants to view or input information into an electronic medical record, electronic medical records application 120 can generate a request for EMR access controller 156 to grant access. If EMR access controller 156 determines that access is authorized (e.g., by looking up access rights in security database 174, inspecting a digital certificate associated with the request, etc.), electronic medical records manager 154 performs the corresponding action in EMR database 170. For example, for a read request, EMR fetch component 160 obtains the desired data from EMR database 170 and transmits the obtained information for display on the requesting user device. For a write request, EMR recorder 158 stores the information from the request in EMR database 170. Various methods of data storage and retrieval are understood by those of skill in the art and are contemplated within the present disclosure. In this manner, electronic medical records manager 154 controls read and write access to electronic medical records stored in EMR database 170.

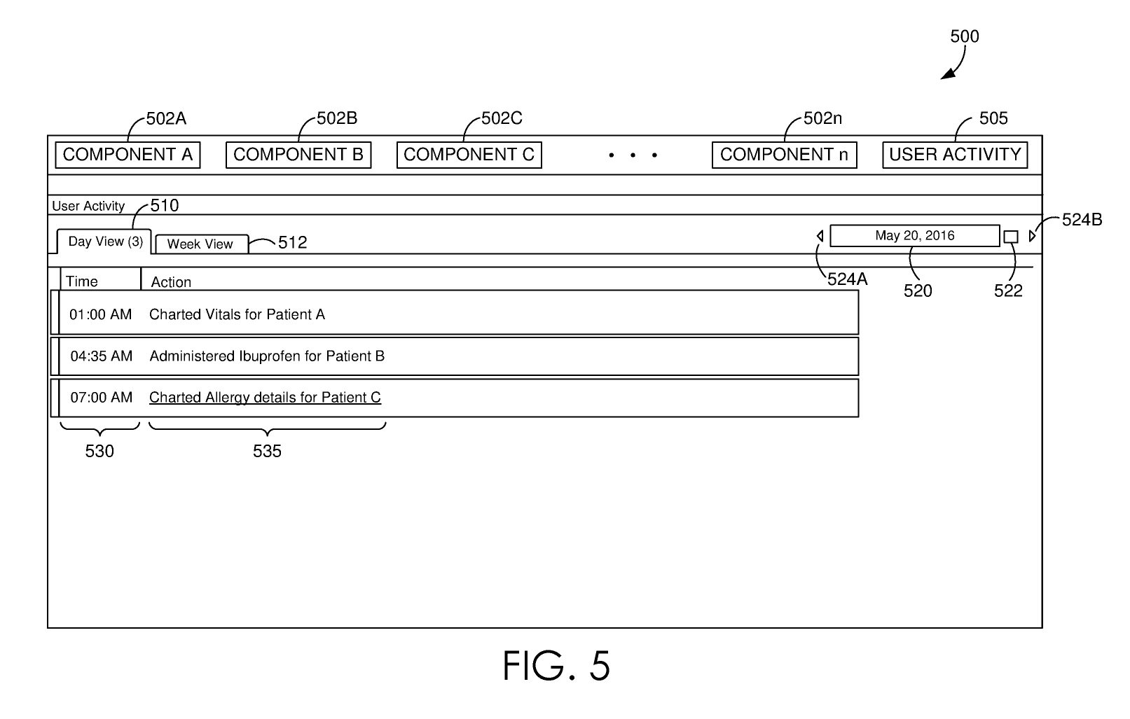

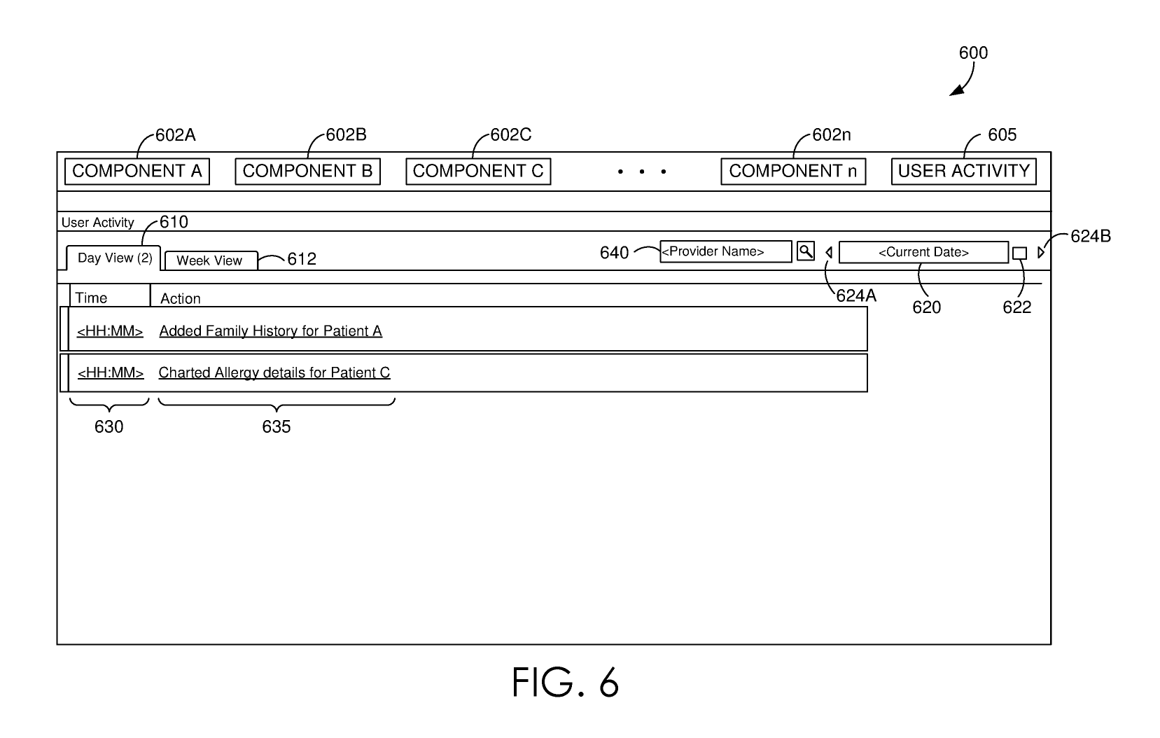

Electronic medical records application 120 includes user activity component 124. User activity component 124 includes a pre-defined configuration, orientation and formatting of various subcomponents for providing a user with an activity history for a specified user. Exemplary user interfaces for user activity component 124 are depicted in FIGS. 5 and 6. Generally, user activity component 124 allows a requesting user to specify a user and facilitates determining whether the reviewing user is authorized to view the activity history for the specified user (e.g., via security component 132 and event access controller 164). When the system determines the requesting user is authorized to view the specified user's activity history, user activity component 124 obtains the activity history (e.g., via event fetch component 168) from events database 172 and presents the activity history to the requesting user (e.g., via user interface 126). User activity component 124 is described in more detail below.

With continued reference to FIG. 1 and facility engine 150, event manager 162 includes event access controller 164, event recorder 166 and event fetch component 168. In the embodiment depicted in FIG. 1, each time a user takes an action in an electronic medical record (e.g., adds or modifies an electronic medical record), a request is sent to facility engine 150, and event recorder 166 extracts information about the event (e.g., user, type of request, details of request, time of request, etc.) and stores the information in events database 172. The events stored in events database 172 are used to provide authorized users with a history of actions taken in one or more electronic medical records by a selected user. The events stored in events database 172 can also be used to generate audit reports.

Generally, event access controller 164 receives requests for access to events database 172. For example, when a requesting user wants to view an activity history comprising all the actions taken by a selected user (whether for him or herself or a reportee) in one or more electronic medical records, the requesting user's electronic medical records application 120 can generate a request that event access controller 164 grant access to the desired data. If event access controller 164 determines that the requesting user is authorized to access the activity history (e.g., by looking up access rights in security database 174, inspecting a digital certificate associated with the request, etc.), event manager 162 retrieves the corresponding actions stored events database 172. For example, if a requesting user requests to view a selected user's activity history for a given electronic medical record, security component 132 on the requesting user's device sends a request to event access controller 164, which verifies the requesting user is authorized to view the selected user's activity history (e.g., based on privilege settings and/or organizational charts stored in a database such as security database 174 and/or fetched from a separate tool). If event access controller 164 grants access, event fetch component 168 obtains the requested data from events database 172 and transmits the obtained information for display on the requesting user device. Various methods of data storage and retrieval are understood by those of skill in the art and are contemplated within the present disclosure. In this manner, event manager 162 controls read and write access to actions stored as events in events database 172.

EMR database 170 is a computer store containing healthcare information for individuals. EMR database 170 includes an electronic version of individual records, such as an electronic medical record, including information for the individual, such as medication and infusion orders, tasks, images, examination reports, testing and lab results, medical history, diagnosis, medical values, etc. EMR database 170 contains the standard medical and clinical data gathered in a provider's office. EMR database 170 is a digital or computerized version of a paper chart that contains all of a patient's medical history.

As used herein, medical professionals may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, students, office assistants and the like. User device 105A, 105B, . . . , 105n can be a remote computer such as a personal computer, smart phone, personal digital assistant, server, router, network PC, peer device, other common network node, or the like, and may include some or all of the components described above in relation to the server. User device 105A, 105B, . . . , 105n may also be physically located in non-traditional medical care environments so that the entire health care community may be capable of integration on the network.

Having identified various components of the autonomous activity tracking system, it is noted that any number of components may be employed to achieve the desired functionality within the scope of the present disclosure. The various components of FIG. 1 are shown with lines for the sake of conceptual clarity, and other arrangements of the described components and/or component functionality are also contemplated. Further, although some components of FIG. 1 are depicted as single components, the depictions are exemplary in nature and in number and are not to be construed as limiting for all implementations of the present disclosure. The autonomous activity tracking system functionality can be further described based on the functionality and features of the above-listed components. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

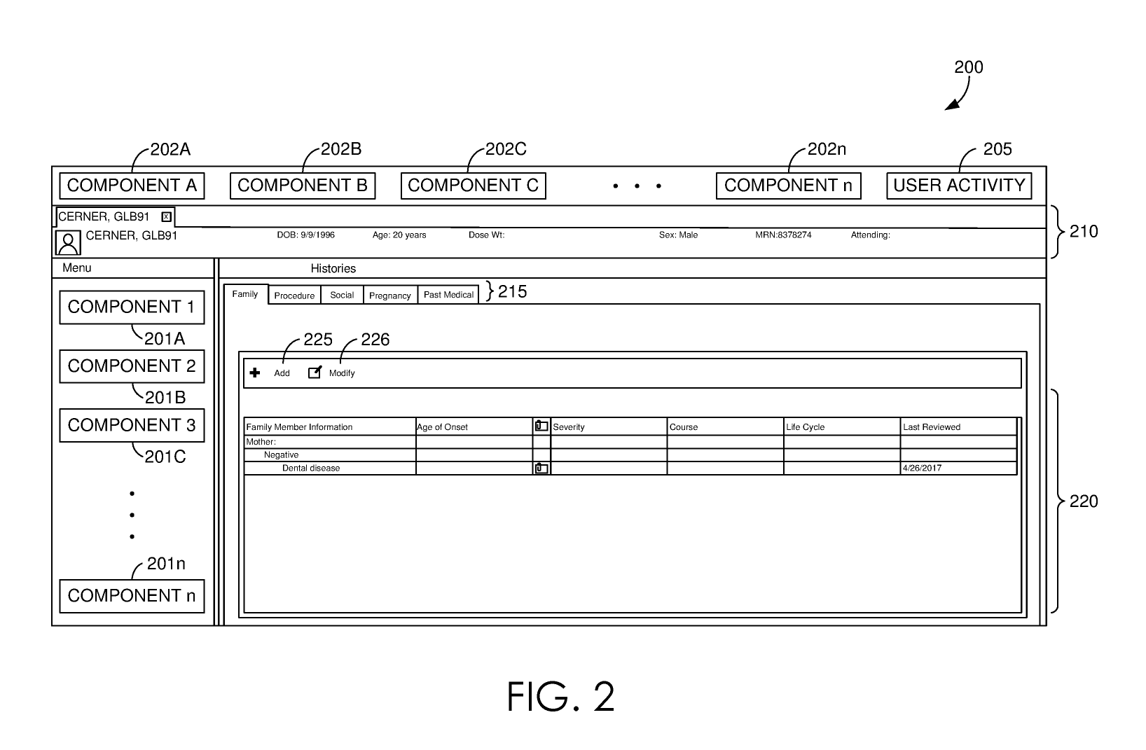

With reference to FIG. 2, FIG. 2 depicts exemplary user interface 200 for a Family History component in an electronic medical records application. The Family History component user interface 200 includes individual information 210 for the fictional individual depicted in FIG. 1, and corresponding family member information 220. The Family History component user interface 200 includes inputs 225 and 226 for adding and modifying family member information 220 (in this case, indicating that the individual's mother is negative for dental disease). The Family History component user interface 200 also includes various navigational components that can be used to navigate to other electronic medical record components. For example, selecting of one of tabs 215 navigates a user to a corresponding history for the individual (e.g., family, procedure, social, pregnancy, past medical). Generally, components 201A, 201B, 201C, . . . , 201n and components 202A, 202B, 202C, . . . , 202n are navigational components that, when selected, navigate the electronic medical records application to a corresponding component of an electronic medical record. Similarly, user activity component 205 of user interface 200 is a navigational component that, when selected, navigates the electronic medical records application to a user activity component such as those depicted in FIGS. 5 and 6 and described in more detail below. The particular user interface depicted in FIG. 2 is exemplary, and various other configurations are contemplated within the present disclosure.

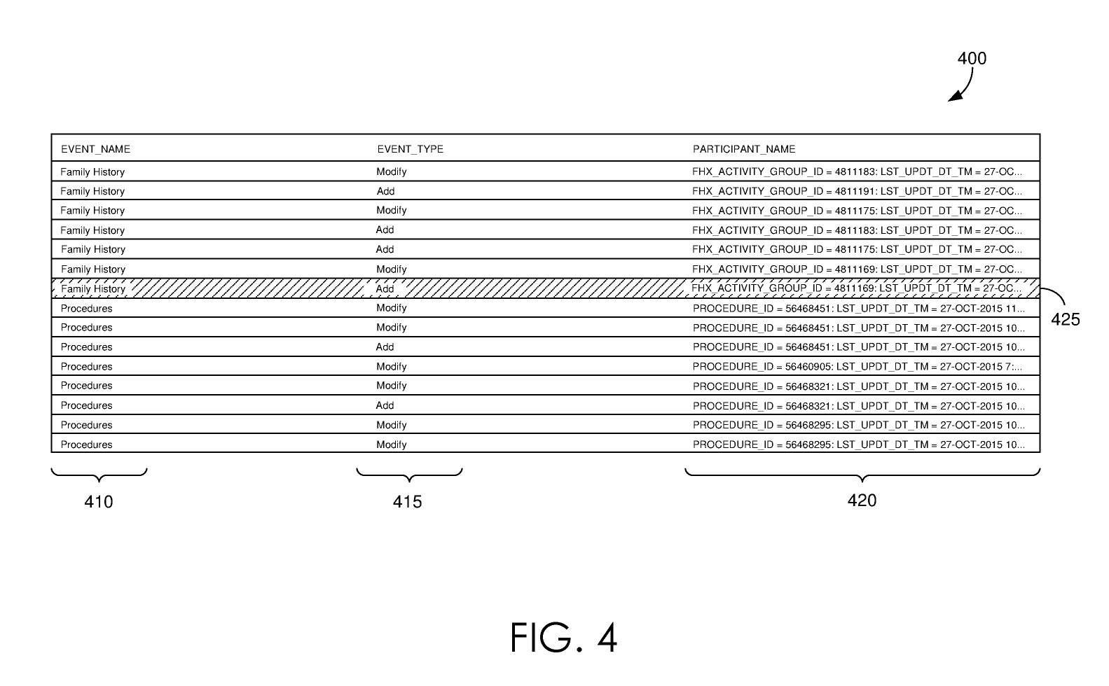

Generally, when a user performs an action within a given electronic medical record component such as the Family History component depicted in FIG. 2, details of the event are captured in an events database as described above. FIG. 4 depicts exemplary data fields that describe actions performed in an electronic medical record and that can be recorded in an events database and used to generate activity histories. Each row in table 400 corresponds to a unique action taken in an electronic medical record. For each action, each of fields 410, 415, and 420 can be populated and used to identify the action as an event in an events database. For example, shaded row 425 indicates in EVENT_NAME field 410 that the action took place in a Family History component. EVENT_TYPE field 415 indicates that the event was an Add event, and PARTICIPANT_NAME field 420 identifies the user who took the action and the time it was performed. The fields depicted in table 400 are merely exemplary, and other variations for storing or otherwise representing actions performed in electronic medical records would be understood by those of skill in the art.

Turning back to a user interface of an electronic medical records application, when a user navigates to a user activity component from within an electronic medical record (e.g., by selecting user activity component 205 of user interface 200), the electronic medical records application can display the user's activity history for one electronic medical record (e.g., a selected record) or multiple electronic medical records (e.g., all records). More specifically, the electronic medical records application can display a user interface for a user activity component such as those depicted in FIGS. 5 and 6. User interface 500 displays each action taken by the user in the electronic medical record in time column 530 and action column 535. In preferred embodiments, the time is displayed in hrs:min format, and the actions are arranged in chronological order. By providing each user with the ability to review his or her own activity history, users are better able to keep track of their own actions and the times at which the actions were performed. User interface 600 likewise displays user activity in time column 630 and action column 635, but additionally permits a requesting user to input 640 a user (e.g., a provider) for which the activity history should be generated. Providing this user activity history to managers, for example, will help managers to monitor the actions of their reportees and facilitate reductions in process-based inefficiencies, training new employees, adherence to recommended workflows, and the like.

User interfaces 500 and 600 include day view tabs 510, 610 and week view tabs 512, 612 for a reviewing user to organize the displayed actions by day and week. User interfaces 500 and 600 also include date selection field 520, 620, calendar popup selection box 522, 622, as well as left navigation arrow 524A, 624A and right navigation arrow 524B, 624B for a reviewing user to select a date or week of interest. As with FIG. 2, navigational components such as components 502A, 502B, 502C, . . . , 502n and 602A, 602B, 602C, . . . , 602n can be provided to navigate to other electronic medical record components.

In preferred embodiments, actions 535, 635 appearing in an activity history comprise hyperlinks to corresponding electronic medical record components in which each action was logged. In some embodiments, hyperlinked actions in an activity history can provide a link to subcomponents (e.g., an add or modify screen) of a corresponding electronic medical record component. In this way, a user can seamlessly navigate between an activity history and the corresponding component or subcomponent in the electronic medical record in which a particular action was generated. In this manner, if a user mistakenly closes a record, clicking on a given action will redirect the user seamlessly to the corresponding component or subcomponent in which the action was logged. Of course, the particular user interfaces depicted in FIGS. 5 and 6 are merely exemplary, and various other configurations are contemplated within the present disclosure.

### Exemplary Flow Diagram

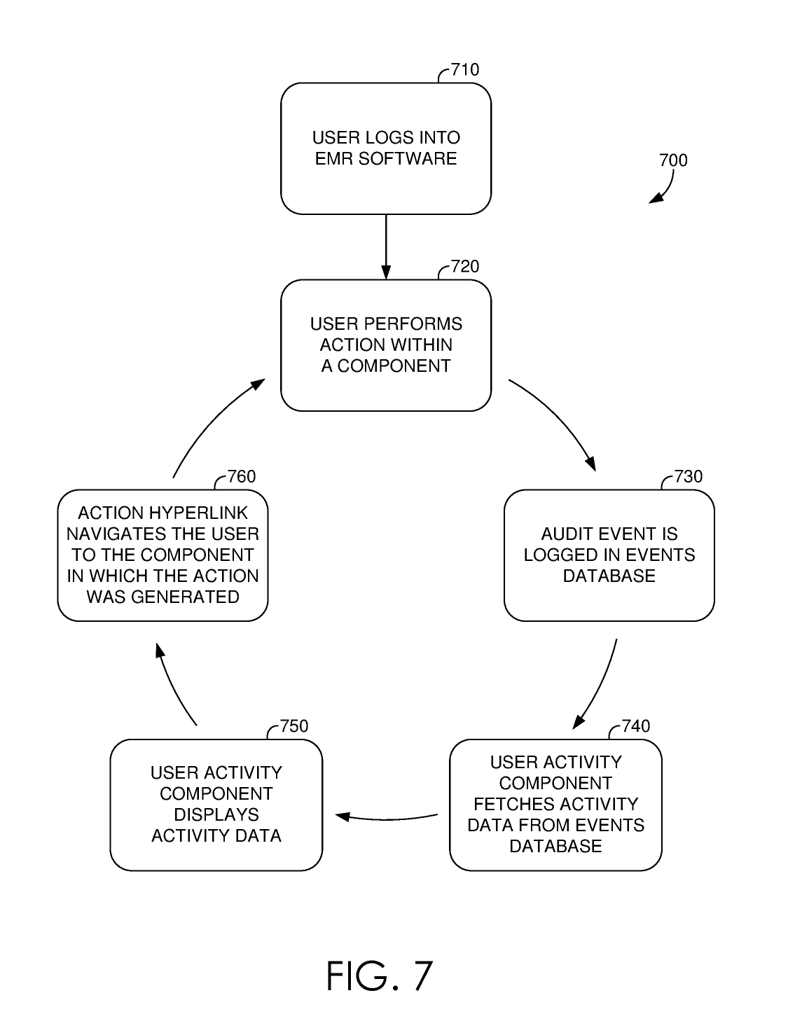

With reference to FIG. 7, a flow diagram is provided illustrating a method 700 for autonomous activity tracking. The method can be performed using the autonomous activity tracking system described herein. In embodiments, one or more computer storage media have computer-executable instructions embodied thereon that, when executed, by one or more processors, can cause the one or more processors to perform the methods in the autonomous activity tracking system. At block 710 a first user logs into electronic medical record software. The system can authenticate the first user in association with a login session. At block 720, the first user performs an action within a component of an electronic medical record. For example, the first user might enter a new family history entry for an individual. At block 730, an audit event is logged in an events database corresponding to the action performed by the first user. When an authorized user requests to view the activity history for the first user, at block 740 a user activity component fetches from an events database activity data comprising information about each action performed by the first user. At block 750, the user activity component displays the fetched activity data for the authorized user as a list of actions. Generally, each listed action includes a hyperlink such that, upon a selection at block 760, the selected hyperlink navigates the authorized user to the component in which the action was generated.

### Exemplary Computing Environment

An exemplary computing environment suitable for use in implementing embodiments of the present invention is described below. FIG. 8 is an exemplary computing environment (e.g., a medical-information computing-system environment) with which embodiments of the present invention may be implemented. The computing environment is illustrated and designated generally as reference numeral 800. Computing environment 800 is merely an example of one suitable computing environment and is not intended to suggest any limitation as to the scope of use or functionality of the invention. Neither should computing environment 800 be interpreted as having any dependency or requirement relating to any single component or combination of components illustrated therein.

The present invention is a special computing system that can leverage well-known computing system environments or configurations. A system, as used herein, refers to any device, process, or service or combination thereof. A system may be implemented using components as hardware, software, firmware, a special-purpose device, or any combination thereof. A system may be integrated into a single device or it may be distributed over multiple devices. The various components of a system may be co-located or distributed. The system may be formed from other systems and components thereof. It should be understood that this and other arrangements described herein are set forth only as examples. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like. Such computing devices include one or more processors that read data from various entities such as memory or input components. Memory includes computer storage media in the form of volatile and/or nonvolatile memory. Memory may be removable, non-removable, or a combination thereof. Exemplary hardware devices include solid-state memory, hard drives, optical-disc drives, etc.

With reference to the autonomous activity tracking system, embodiments described herein support autonomous activity tracking. The autonomous activity tracking system components refer to integrated components for autonomous activity tracking. The integrated components refer to the hardware architecture and software framework that support networking, data storage and access, and activity tracking functionality using the autonomous activity tracking system. The hardware architecture refers to physical components and interrelationships thereof and the software framework refers to software providing functionality that can be implemented with hardware embodied on a device.

The end-to-end software-based autonomous activity tracking system can operate within the autonomous activity tracking system components to operate computer hardware to provide autonomous activity tracking system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the autonomous activity tracking system components can manage resources and provide services for the autonomous activity tracking system functionality. Other variations and combinations of components and functionality are contemplated with embodiments of the present invention.

By way of example, the autonomous activity tracking system can include an API library that includes specifications for routines, data structures, object classes, and variables may support the interaction between the hardware architecture of the device and the software framework of the autonomous activity tracking system. These APIs include configuration specifications for the autonomous activity tracking system such that the different components therein can communicate with each other in the autonomous activity tracking system, as described herein.

The present invention might be described in the context of computer-executable instructions, such as program modules, being executed by a computer or other machine, such as a personal data assistant or other handheld device. Exemplary program modules comprise routines, programs, objects, components, and data structures and refer to code that perform particular tasks or implement particular abstract data types. The invention may be practiced in a variety of system configurations, including hand-held devices, consumer electronics, general-purpose computers, more specialty computing devices, etc. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 8, the computing environment 800 comprises a computing device in the form of control server 802. Exemplary components of control server 802 include a processing unit, internal system memory, and a suitable system bus for coupling various system components, including data store 804, with control server 802. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Control server 802 typically includes therein, or has access to, a variety of non-transitory computer-readable media. Computer-readable media can be any available media that might be accessed by control server 802, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 802. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Control server 802 might operate with network 806, using logical connections to one or more remote computers 808. Remote computers 808 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. Remote computers 808 might also be physically located in nontraditional medical care environments so that the entire healthcare community might be capable of integration on the network. Remote computers 808 might be personal computers, servers, routers, network PCs, peer devices, other common network nodes, or the like and might comprise some or all of the elements described above in relation to control server 802. The devices can be cell phones, personal digital assistants or other like devices.

Network 806 comprises one or more local area networks (LANs) and/or one or more wide area networks (WANs). Such networking environments are commonplace in offices, enterprise-wide computer networks, intranets, and the Internet. When utilized in a WAN networking environment, control server 802 might comprise a modem or other means for establishing communications over the WAN, such as the Internet. In such a networking environment, program modules or portions thereof might be stored in association with control server 802, data store 804, or any of remote computers 808. For example, various application programs may reside on the memory associated with any one or more of remote computers 808. It will be appreciated by those of ordinary skill in the art that the network connections shown are exemplary and other means of establishing a communications link between the computers (e.g., control server 802 and remote computers 808) might be utilized.

In operation, an organization might enter commands and information into control server 802 or convey the commands and information to the control server 802 via one or more of remote computers 808 through input devices, such as a keyboard, a microphone (e.g., voice inputs), a touch screen, a pointing device (commonly referred to as a mouse), a trackball, or a touch pad. Other input devices comprise satellite dishes, scanners, or the like. Commands and information might also be sent directly from a remote healthcare device to control server 802. In addition to a monitor, control server 802 and/or remote computers 808 might comprise other peripheral output devices, such as speakers and a printer.

Although many other internal components of control server 802 and remote computers 808 are not shown, such components and their interconnection are well known. Accordingly, additional details concerning the internal construction of control server 802 and the remote computers 808 are not further disclosed herein.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a computing environment in a medical facility; however the computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the autonomous activity tracking system and the schematics described herein, it is understood that the techniques described may be extended to other implementation contexts.

The present invention has been described in relation to particular embodiments, which are intended in all respects to be illustrative rather than restrictive. Further, the present invention is not limited to these embodiments, but variations and modifications may be made without departing from the scope of the present invention.

1. A system for implementing activity tracking in electronic medical records, the system comprising:
a hardware processor configured to perform a predefined set of basic operations in response to receiving a corresponding basic instruction selected from a predefined native instruction set of codes;
memory;
an electronic medical records manager comprising:
a first set of machine codes selected from the native instruction set and configured to receive a request from a first user to perform an action in a component of an electronic medical record; and
a second set of machine codes selected from the native instruction set and configured to perform the action in an electronic medical records database; and
an event manager comprising:
a third set of machine codes selected from the native instruction set and configured to log an audit event corresponding to the action in an events database;
a fourth set of machine codes selected from the native instruction set and configured to receive a request from a second user to access an activity history for the first user comprising actions performed by the first user in the electronic medical record;
a fifth set of machine codes selected from the native instruction set and configured to determine whether the second user is authorized to access the activity history;
a sixth set of machine codes selected from the native instruction set and configured to fetch information about the action from the logged audit event when the second user is authorized; and
a seventh set of machine codes selected from the native instruction set and configured to provide the information for display to the second user as an activity history.

2. The system of claim 1, wherein the first user and the second user are the same user.

3. The system of claim 1, wherein the sixth set of machine codes is additionally configured to exclude at least one data field stored in the events database for the action.

4. The system of claim 1, wherein the fifth set of machine codes is additionally configured to determine the authorization based on a privilege setting for the second user stored in a security database.

5. The system of claim 1, additionally comprising:
a user device including a hardware processor configured to perform a predefined set of basic operations in response to receiving a corresponding basic instruction selected from a second predefined native instruction set of codes;
memory; and
a user activity component comprising a first set of machine codes selected from the second native instruction set and configured to present each action in the activity history with a hyperlink to a corresponding component in the electronic medical record in which the action was generated.

6. The system of claim 1, additionally comprising a seventh set of machine codes selected from the native instruction set and configured to authenticate a user for a login session.

7. The system of claim 1, additionally comprising an eighth set of machine codes selected from the native instruction set and configured to generate an audit report using the logged audit event.

8. A system for implementing activity tracking in electronic medical records, the system comprising:
a means for receiving a request from a first user to perform an action in a component of an electronic medical record;
a means for performing the action in an electronic medical records database;
a means for logging an audit event corresponding to the action in an events database;
a means for receiving a request from a second user to access an activity history for the first user comprising actions performed by the first user in the electronic medical record;
a means for determining authorization of the second user to access the activity history;
a means for fetching information about the action from the logged audit event when the second user is authorized; and
a means for providing the information for display to the second user as an activity history.

9. The system of claim 8, wherein the first user and the second user are the same user.

10. The system of claim 8, wherein the means for fetching information about the action is configured to exclude at least one data field stored in the events database for the action.

11. The system of claim 8, wherein the means for determining authorization is based on a privilege setting for the second user stored in a security database.

12. The system of claim 8, additionally comprising a user device including a hardware processor, memory, and a user activity component configured to present each action in the activity history with a hyperlink to a corresponding component in the electronic medical record in which the action was generated.

13. The system of claim 8, additionally comprising a means for authenticating a user for a login session.

14. The system of claim 8, wherein the logged audit event can be used to generate an audit report.

15. One or more computer storage media having computer-usable instructions that, when used by one or more computing devices, cause the one or more computing devices to perform a method for activity tracking in electronic medical records, the method comprising:
providing a user activity component on a user device configured to receive a request from a reviewing user to access an activity history of a selected user, the activity history comprising actions performed by the selected user in an electronic medical record;
providing security credentials for the reviewing user for a determination whether the reviewing user is authorized to access the activity history of the selected user; and
when the reviewing user is authorized, fetching information identifying the actions performed by the selected user from an events database and displaying the information as an activity history in the user activity component.

16. The media of claim 15, wherein each action in the displayed activity history comprises a hyperlink to a corresponding component in the electronic medical record in which the action was generated.

17. The media of claim 15, wherein access to the activity history is read-only.

18. The media of claim 15, further comprising displaying the actions in the activity history in chronological order.

19. The media of claim 15, wherein the activity history excludes at least one data field stored in the events database for the actions.

20. The media of claim 15, wherein the authorization determination is based on a privilege setting for the reviewing user stored in a security database.
